(19) United States
(12) Patent Application Publication
(10) Pub. No.: US 2017/0297189 A1
(43) Pub. Date: Oct. 19, 2017

(54) Hammer with Recessed Blade

(71) Applicant: Stanley Black & Decker, Inc., New Britain, CT (US)

(72) Inventor: Keith M. Lombardi, Avon, CT (US)

(21) Appl. No.: 15/479,984

(22) Filed: Apr. 5, 2017

Related U.S. Application Data
(60) Provisional application No. 62/324,707, filed on Apr. 19, 2016.

(51) Int. Cl. B25F 1/00; B25D 1/04

(52) U.S. Cl. CPC B25F 1/006; B25D 1/04

(57) ABSTRACT

A tool includes a handle portion, a head portion at an end of the handle portion, a hammer strike surface at a forward region of the head portion, an upper extension and a lower extension of the head portion extending away from the head portion, defining a gap between the upper extension and the lower extension, and a blade formed in the head portion, recessed within the gap between the upper extension and the lower extension.

### FIELD OF THE INVENTION

The present invention relates generally to hand tools, and more specifically to hammers.

### DESCRIPTION OF RELATED ART

There are many hammer-type hand tools that are traditionally used for demolition of construction or building materials. For example, U.S. Pat. No. 8,117,702 shows a multi-function demolition tool that includes a hammer strike surface and a board engagement surface at one end thereof, and a nail pulling surface at an opposite end thereof, separated by a handle surface.

In some demolition purposes, a sharpened blade, such as on an axe, may be useful to split or otherwise cut into lumber, drywall, or other such substrates. While some specialty hammer-type hand tools may include “blades” for various associated purposes (e.g., U.S. Pat. No. 6,460,210, showing blades on a slate hammer), it may be appreciated that such specialty hammer-type hand tools would generally either have a relatively dulled cutting edge (e.g., as in a slate hammer designed for cutting stone), or would have the intrinsic danger associated with an exposed cutting surface on a swinging instrument, such as would be found in a hatchet or axe.

### SUMMARY OF THE INVENTION

According to one aspect of this disclosure, a tool includes a handle portion, a head portion at an end of the handle portion, a hammer strike surface at a forward region of the head portion, an upper extension and a lower extension of the head portion extending away from the head portion, defining a gap between the upper extension and the lower extension, and a blade formed in the head portion, recessed within the gap between the upper extension and the lower extension.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only, and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

### BRIEF DESCRIPTION OF THE DRAWINGS

Features of hammers in accordance with one or more embodiments are shown in the drawings, in which like reference numerals designate like elements. The drawings form part of this original disclosure in which:

FIG. 1 illustrates a side view of an embodiment of a hammer according to an aspect of the present disclosure;

FIG. 2 illustrates a side view of another embodiment of a hammer according to an aspect of the present disclosure, grasping a piece of lumber therein; and

FIG. 3 illustrates an isolated perspective view of a portion of the hammer of FIG. 2.

### DETAILED DESCRIPTION OF THE ILLUSTRATED EMBODIMENT(S)

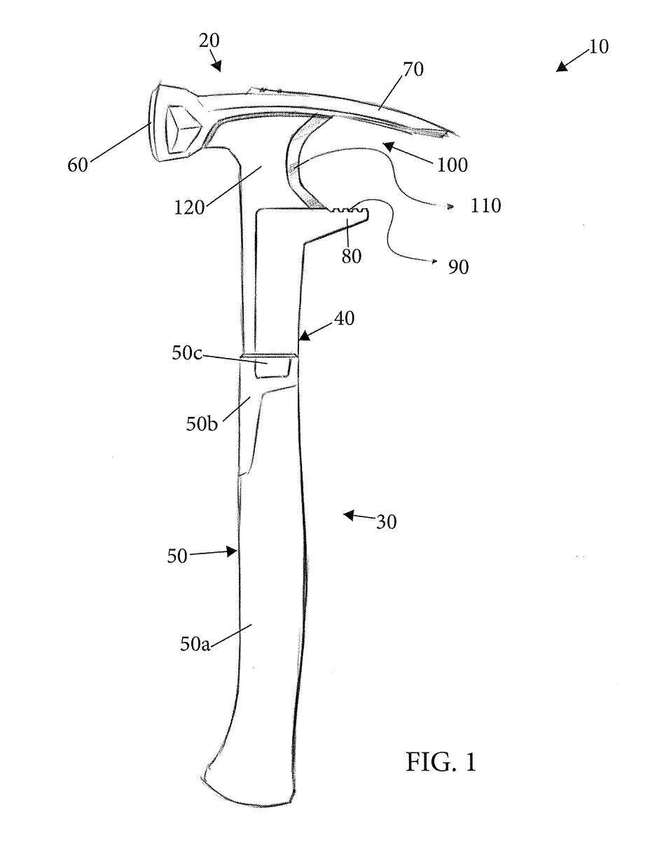

FIG. 1 illustrates a side view of a hammer 10 of the present disclosure. The hammer 10 includes a head portion 20, and a handle portion 30. In some embodiments, at least portions of the head portion 20 and the handle portion 30 are formed integrally to one another, including but not limited to being molded integrally to one another. In other embodiments, at least portions of the head portion 20 and the handle portion 30 are permanently affixed, such as through being welded together. In the illustrated embodiment, the head portion 20 extends into a core 40 of the handle portion 30, which is embedded within a grip member 50. It may be appreciated that the grip member 50 may be of any appropriate material or combination of materials, including but not limited to rubber or plastic (such materials which may be overmolded onto the core 40 of the handle portion 30 in some embodiments). For example, in the illustrated embodiment, the grip member 50 includes multiple overmolded components 50a, 50b, and 50c. In some embodiments, the grip member 50 may be formed of wood, fiberglass, or similar materials, which may be fixed to the core 40 or other portions of the head portion 20 by appropriate fasteners. In some embodiments the grip member 50 or other parts of the handle portion 30 may be received within the head portion 20, or may be secured adjacent to the head portion 20 by intermediate members.

As shown in FIG. 1, the head portion 20 includes a hammer strike face 60. The hammer strike face 60 may be flat, curved, checkered/stippled, and/or of any other configuration known in the art. As shown, opposite the hammer strike face 60 along the head portion 20 is an upper extension 70. In an embodiment, the upper extension 70 is formed as a nail pull, as described in greater detail below. It may be appreciated that the upper extension 70 may be formed as a rip/straight claw, a curve claw, or any other appropriate shape.

Spaced from the upper extension 70, downward closer to the handle portion 30 is a lower extension 80. It may be appreciated that the upper extension 70 and the lower extension 80 define a gap 100 therebetween. In an embodiment, the gap 100 may be sized appropriately to engage a standard size piece of lumber, for example, a 2×4 board. For example, in an embodiment the gap 100 may be approximately 2″, or may be approximately 4″ (as is understood in the art, a 2×4 board is generally smaller than 2″×4″, so the gap may be approximately 1.5″ or may be approximately 3.5″ in other embodiments, or still other sizes in other embodiments). In an embodiment one or more of the upper extension 70 and the lower extension 80 may be configured to grasp a board received in the gap 100. For example, in the illustrated embodiment, the lower extension 80 is formed as a board grabbing jaw, and has a board engagement surface 90 thereon, facing the gap 100. In some embodiments, the board engagement surface 90 may be toothed, stippled, grooved, knurled, or otherwise textured or shaped to bite into or otherwise provide traction when engaging a board.

Recessed in the gap 100 between the upper extension 70 and the lower extension 80 is a blade 110 formed in a body 120 of the head portion 20. It may be appreciated that the blade 110 may be sharpened on one or both sides, and may form a sharp cutting surface or a duller wedge in various embodiments. In an embodiment, the gap 100 between the upper extension 70 and the lower extension 80 may be sized and shaped so that insertion of a standard size piece of lumber (e.g., a 2×4) at a particular angle may catch the lumber between the upper extension 70 and the board engagement surface 90 to facilitate twisting and pulling the lumber, while the gap 100 is sized sufficiently to receive the lumber at another angle so that the lumber contacts the blade 110. As one example, where the gap 100 is sized to engage a 2×4 board on the longer side, such a size would facilitate striking at the shorter side of the board so that the board impacts the blade 110 similar to acting as a hatchet for chopping or splitting functions. In other embodiments, the blade 110 may be sized for cutting smaller substrates than the lumber intended to be grasped by the board engagement surface 90. For example, the blade may be sized and shaped on the body 120 to score or cut drywall, pipes, wires, or other smaller substrates received through the gap 100. It may also be appreciated that the recession of the blade 110 within the gap 100 may prevent inadvertent contact (either by a user or by an unintended substrate) with the blade 110. In an embodiment, the hammer strike face 60 may be machined to both provide hammer strikes as well as to receive hammer strikes from another impactor (e.g., another hammer). It may be appreciated that in such embodiments, impacting the hammer strike surface 60 may drive the blade 110 through a substrate received in the gap 100.

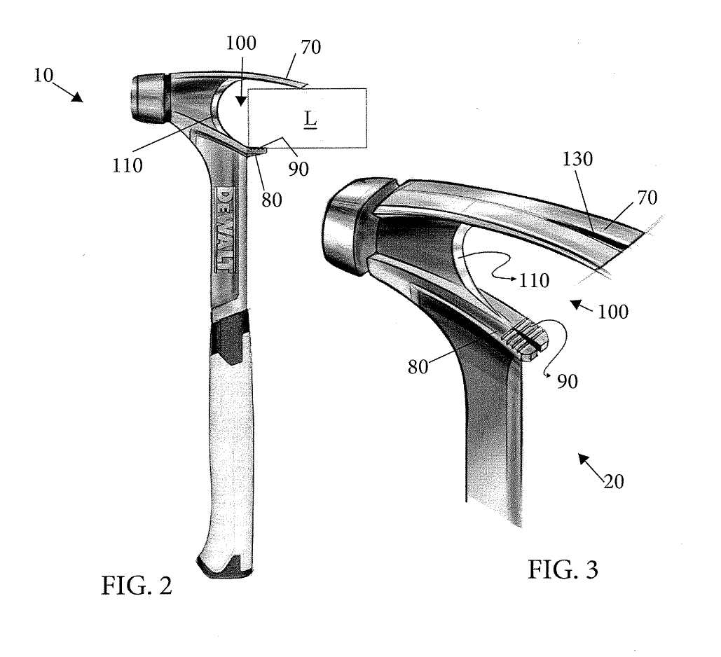

FIG. 2 illustrates another embodiment of the hammer 10, having a different industrial design than that of FIG. 1. As shown, the upper extension 70 and the lower extension 80 may be spaced so that portions of each (e.g., the board engagement surface 90) may contact a piece of lumber L inserted therein. It may be appreciated that tilting the lumber L relative to the upper extension 70 and lower extension 80 may facilitate the lumber L passing through the gap 100 and coming into contact with the blade 110.

FIG. 3 illustrates a perspective view of an embodiment of the head portion 20, further showing embodiments of the upper extension 70 and lower extension 80, separated by the gap 100 with the blade 110 recessed within. As shown, the illustrated embodiment includes a curved configuration of upper extension 70, with a nail pull slot 130 formed therein, facilitating prying of nails using the upper extension 70 as a fulcrum. Similarly, in an embodiment the lower extension 80 may include a flanged configuration outward (e.g., with a slot therein) to provide a wider grasping area for the board engagement surface 90.

It may be appreciated that the components described herein may be of different constructions or configurations, including but not limited to one or more being comprised of different material choices. For example, the components described herein may each be constructed from a variety of materials, including but not limited to one or more plastics, metals, rubbers, elastomers, or any other appropriate material choice. For example, in an embodiment one or more of the components may be formed of aluminum (e.g., machined aluminum), iron (e.g., steel), or any other appropriate material. In some embodiments, the material choices may differ from component to component.

Although aspects of the invention have been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A tool comprising:
a handle portion;
a head portion at an end of the handle portion;
a hammer strike surface at a forward region of the head portion;
an upper extension and a lower extension of the head portion extending away from the head portion, defining a gap between the upper extension and the lower extension; and
a blade formed in the head portion, recessed within the gap between the upper extension and the lower extension.

2. The tool of claim 1, wherein one or more of the upper extension and the lower extension comprises a board engagement surface.

3. The tool of claim 2, wherein the board engagement surface comprises one or more of teeth, grooves, stipples, knurls, or other textured configurations to facilitate board engagement.

4. The tool of claim 1, wherein the gap separating the upper extension and the lower extension is approximately 1.5″, approximately 2″, approximately 3.5″, or approximately 4″.

5. The tool of claim 1, wherein the upper extension comprises a nail pull slot.

6. The tool of claim 1, wherein the blade is sharpened for splitting or chopping of a substrate.

7. The tool of claim 1, wherein the blade is formed as a wedge.

8. The tool of claim 1, wherein the hammer strike surface is shaped to receive external impact blows, and wherein the blade is positioned relative to the hammer strike surface such that impact blows to the hammer strike surface drives the blade into a substrate placed in the gap.

9. The tool of claim 1, wherein the handle portion and the head portion are integrally formed together.

10. The tool of claim 1, wherein the head portion is a unitary construction.

11. The tool of claim 1, wherein the handle is wood, fiberglass, or plastic.
